(19) United States
(12) Patent Application Publication
(10) Pub. No.: US 2008/0185835 A1
(43) Pub. Date: Aug. 7, 2008

(54) Seba nationwide auto repairs and traffic ticket insurance

(76) Inventor: Lillie M. Bolongia, Dalllas, TX (US)

Correspondence Address: Lillie M. Bolongia, P.O. Box 270399, Dallas, TX, 75227-0399, US

(21) Appl. No.: 11/586,011

(22) Filed: Feb. 3, 2007

(51) Int. Cl. B42D 15/00

(52) U.S. Cl. 283/54

(57) ABSTRACT

This present invention provides a process and method for insuring Auto Repairs and Traffic Ticket insurance to pre-qualified policyholders. The process comprises methods for obtaining information from prospective policyholders, qualifying claims, and paying out claims for traffic tickets and auto repairs.

### BRIEF DESCRIPTION OF THE DRAWINGS

The method & service features and of the method is set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1

Application for traffic Ticket violations for Truckers only. The prospective policyholder will receive, fill out and submit the application FIG. 3 as a means for obtaining approval of coverage, with detailed, outlined disclosures.

FIG. 2

Application for traffic Ticket violations for Automobiles only. The prospective policyholder will receive, fill out and submit the application in FIG. 4 as a means for obtaining approval of coverage, with detailed, outlined disclosures.

FIG. 3

Application for Auto Repairs Insurance, both truck and car. The prospective policyholders will receive, fill out and submit the application in FIG. 5 as a means for obtaining approval of coverage, with detailed, outlined disclosures.

FIG. 4

Proof of Coverage card. The policy holder will be instructed to keep this in their vehicle in all times.

FIG. 5

Request and approval form to obtain DMV records, from prospective policyholder as a means for approval.

FIG. 6

Vehicle Inspection forms. These forms will be used as a means for accessing prospective policyholders' determination of coverage.

FIG. 7

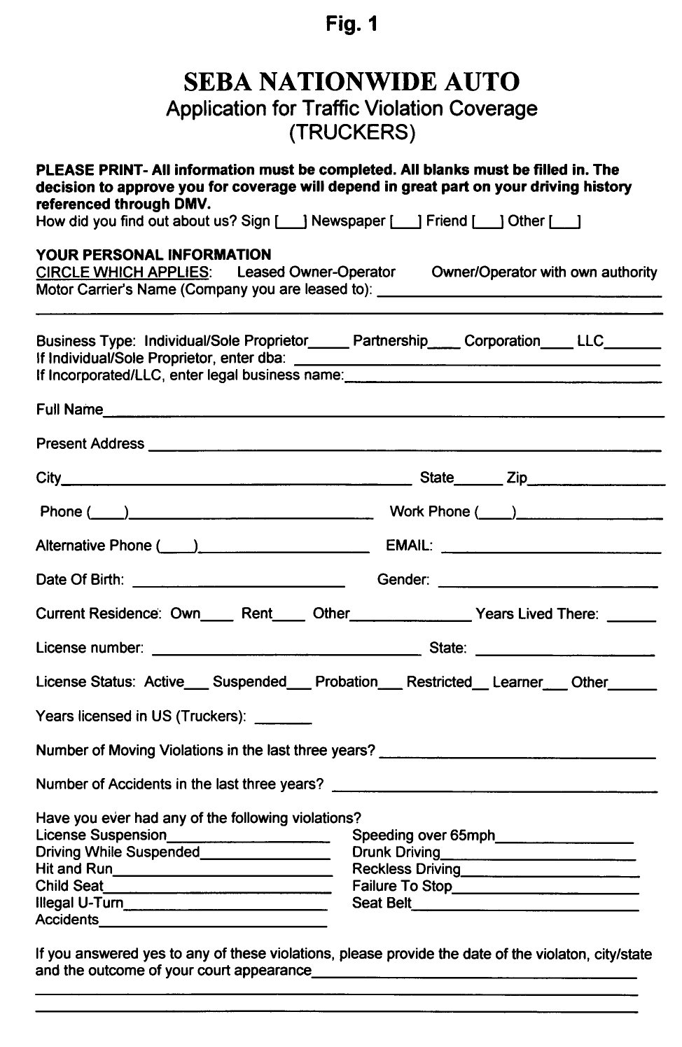

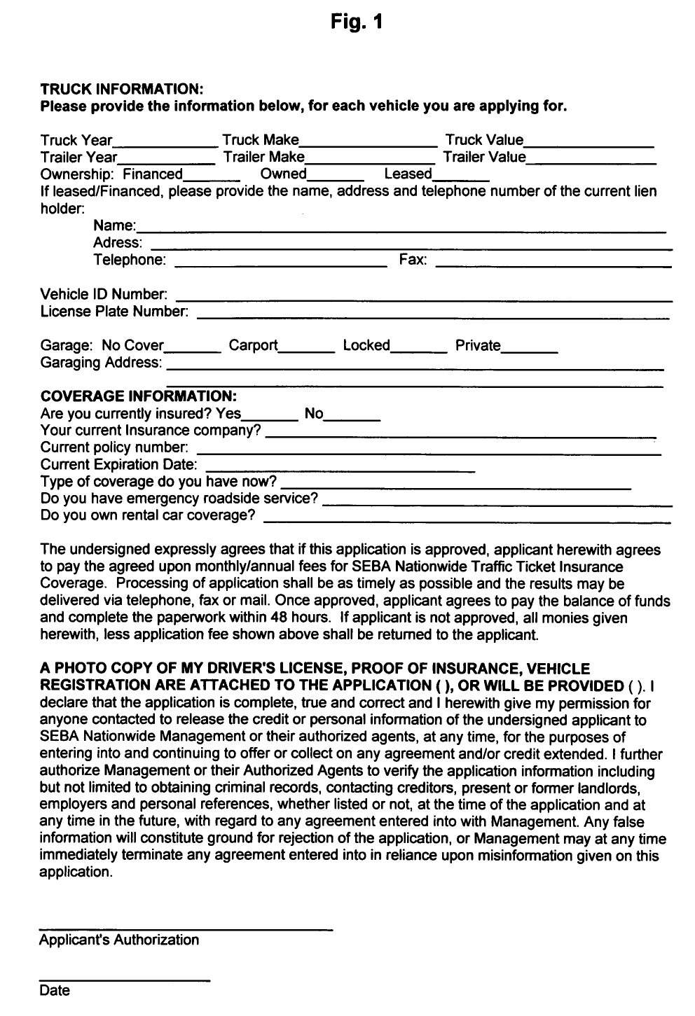

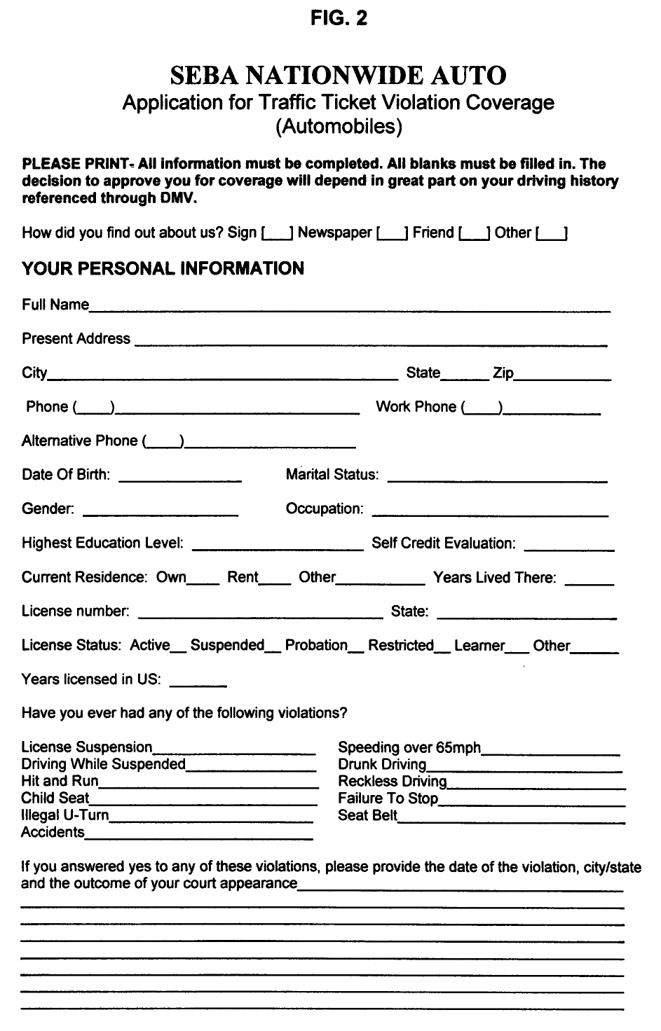

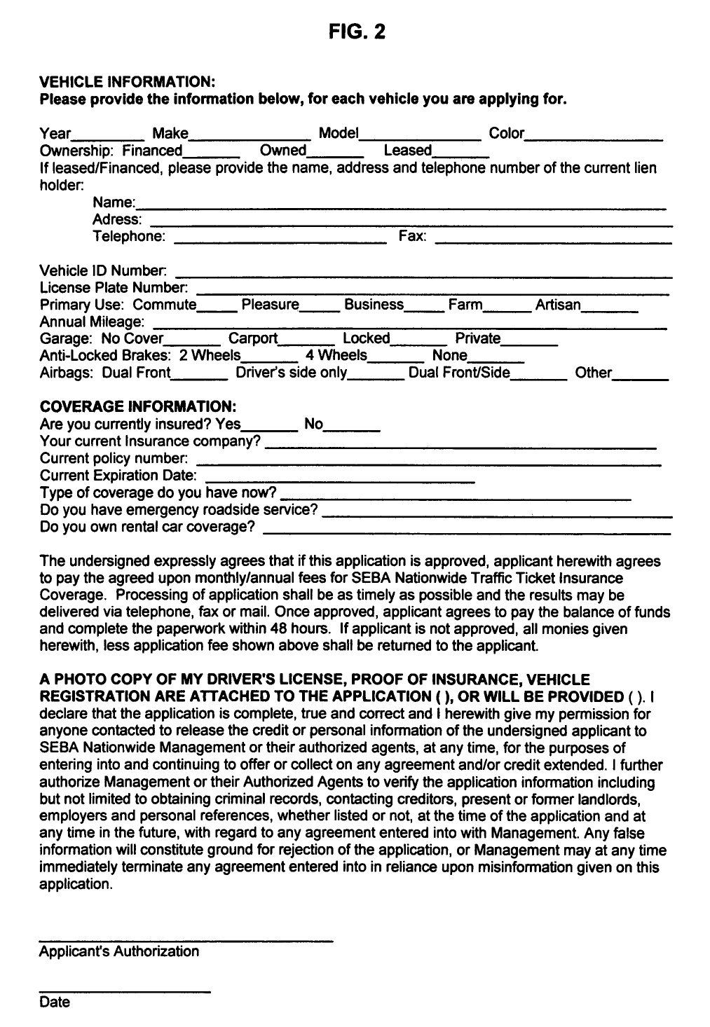

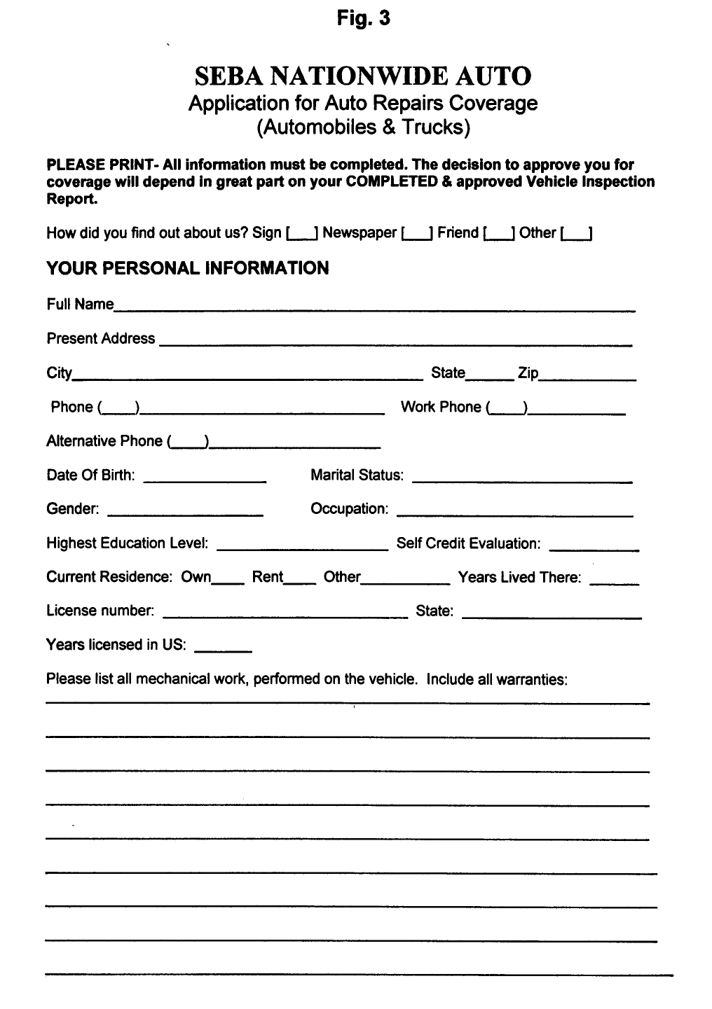

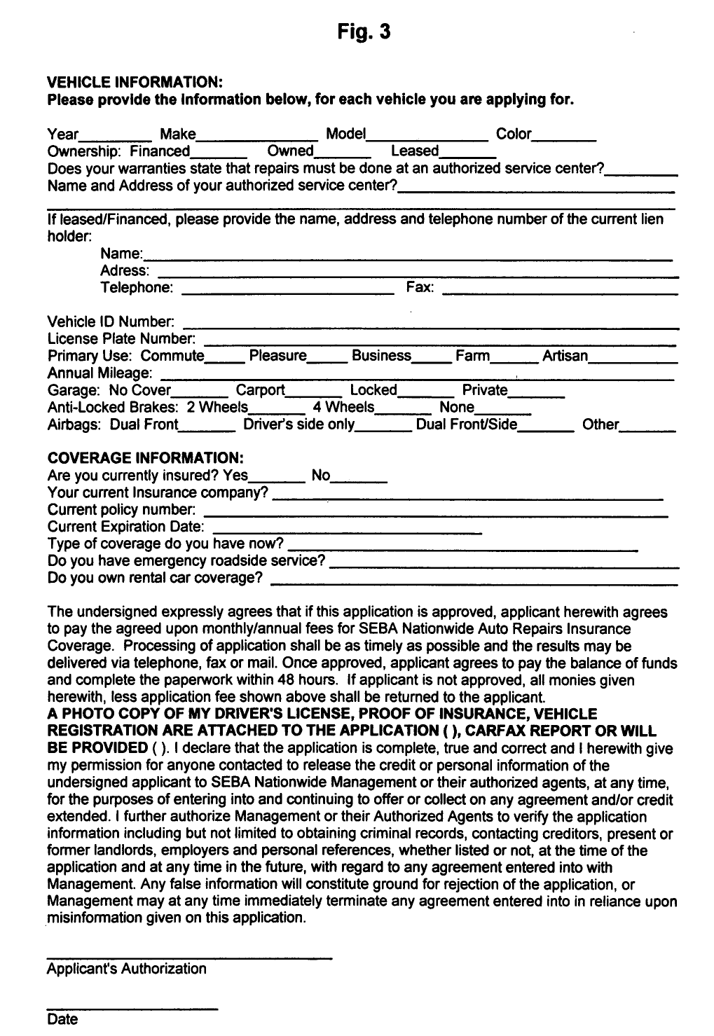

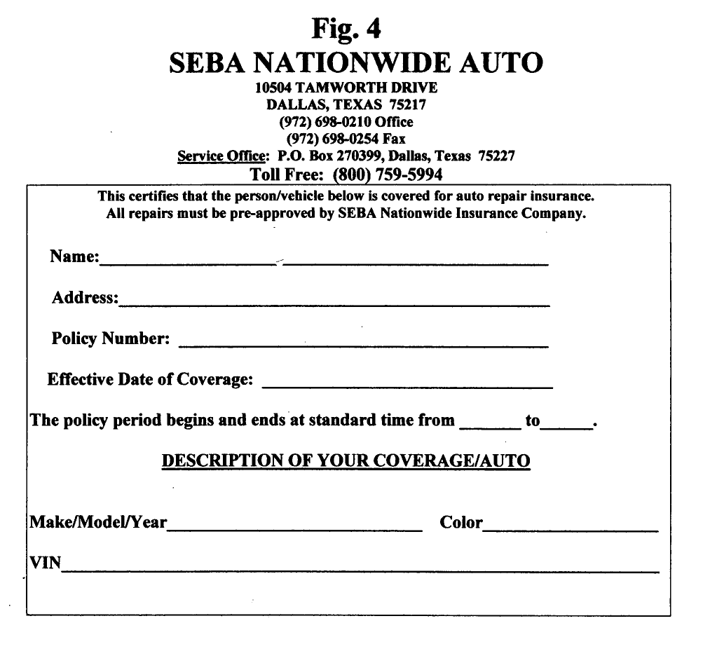

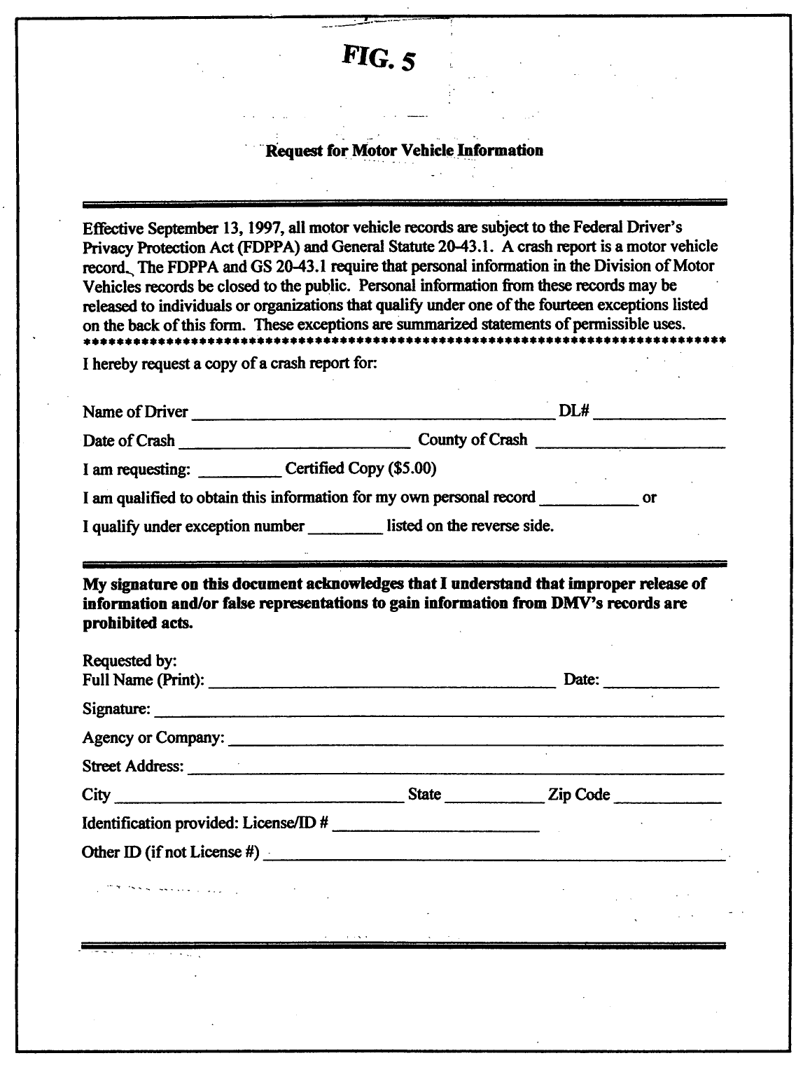

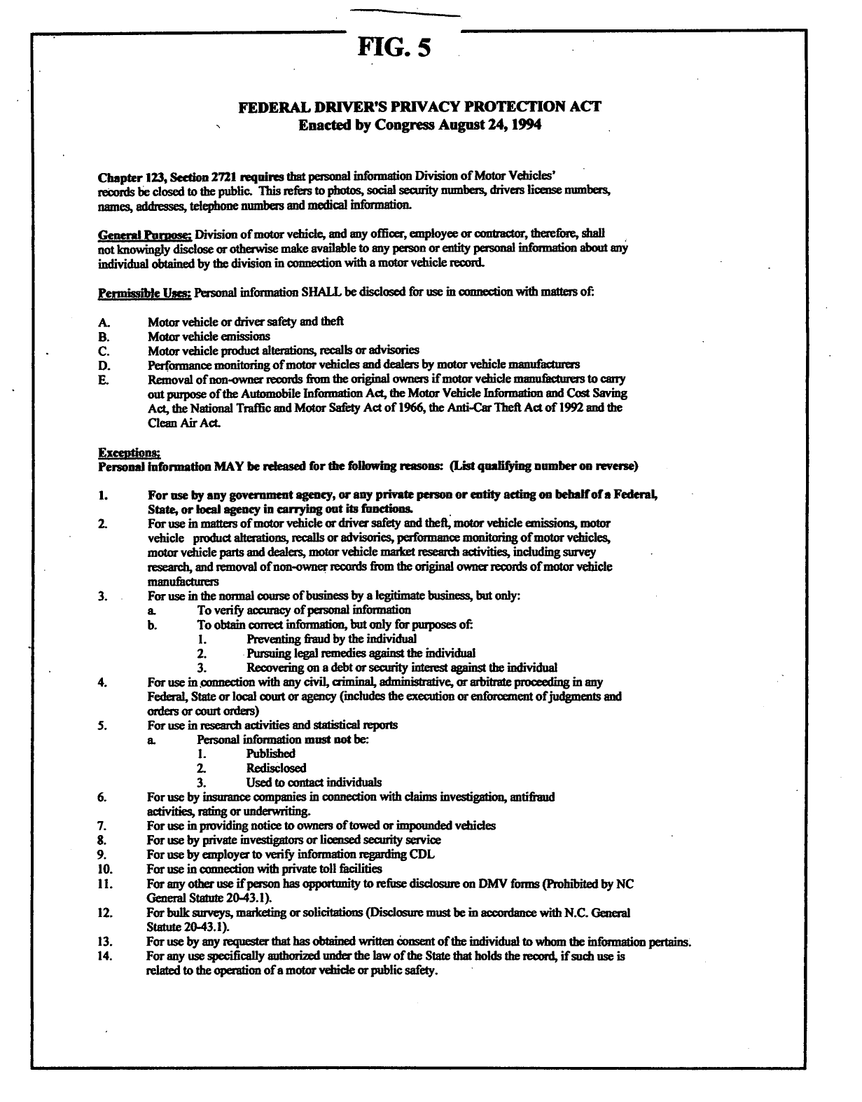

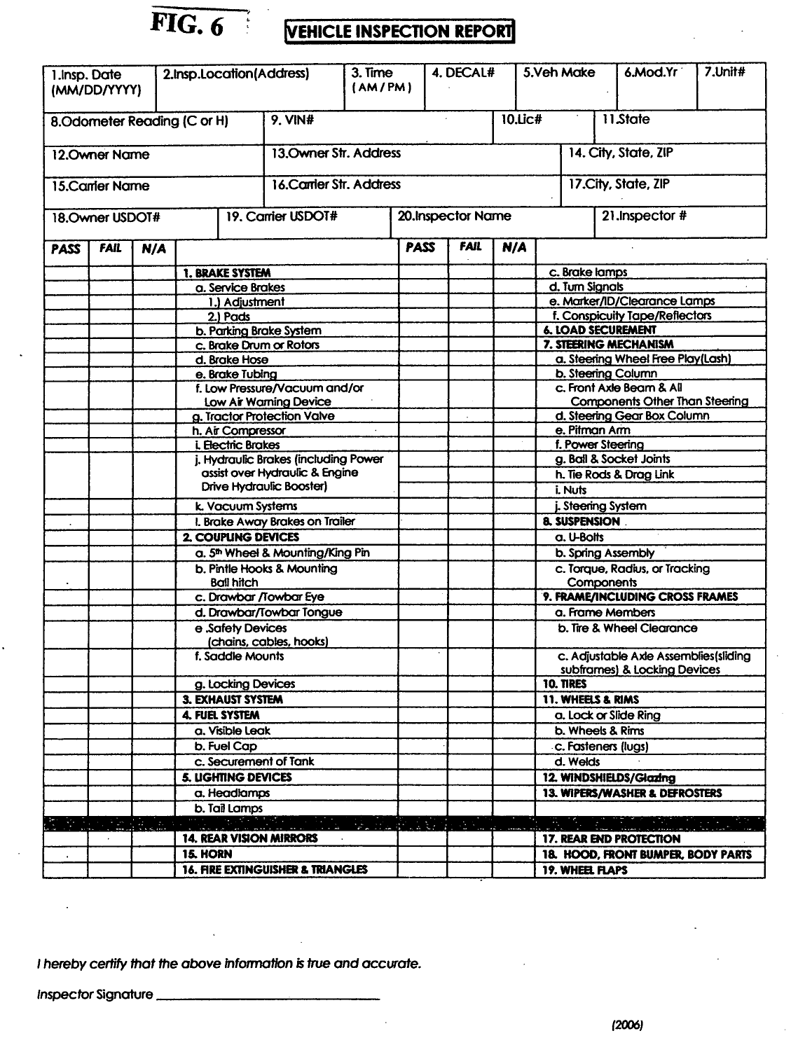

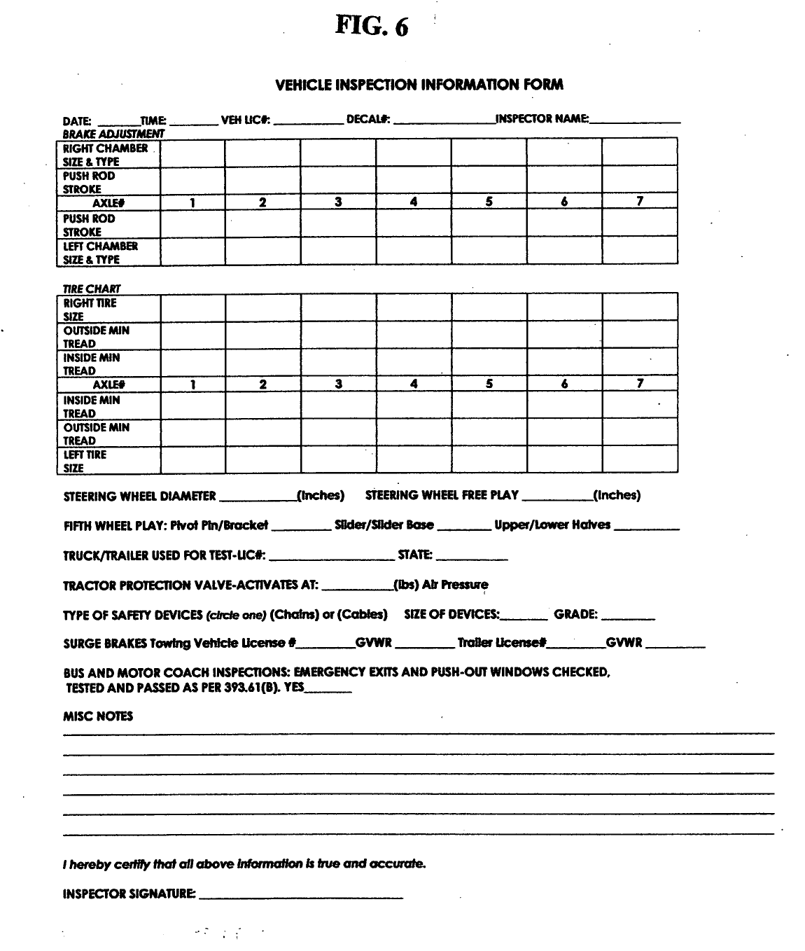

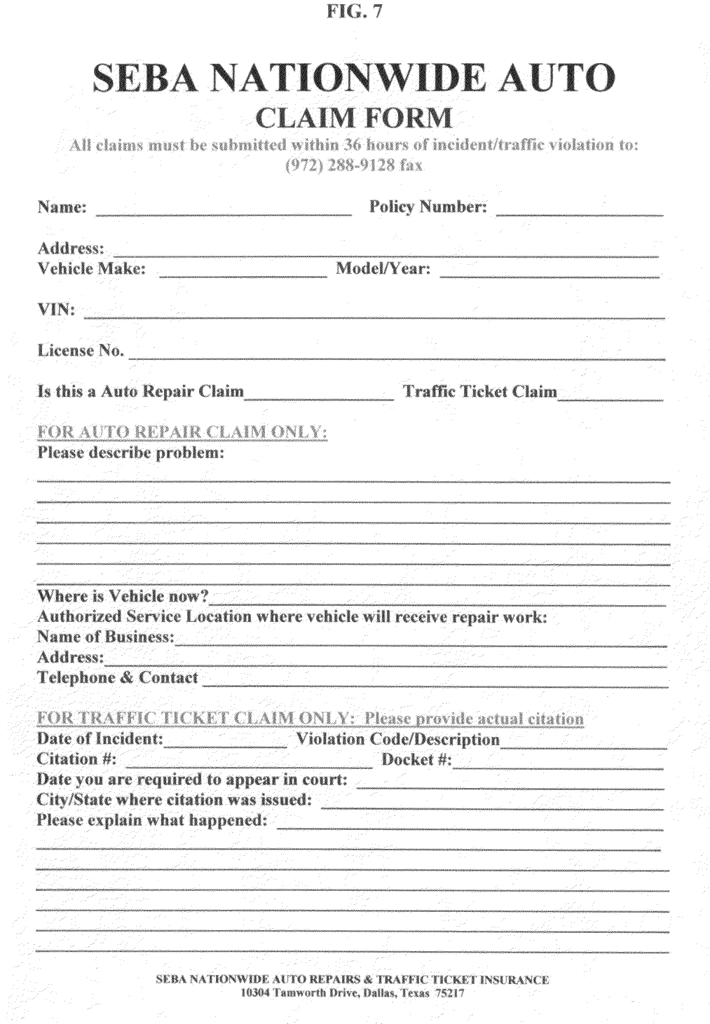

To file a claim, the insured policyholder will fill out the form in FIG. 7 and email or fax to SEBA Nationwide Auto Repairs and Ticket Insurance, within all disclosed guidelines.

I claim:

1. A nationwide Auto Repairs and Traffic ticket insurance to insure one from unexpected expense of auto repairs, to eliminate the time consuming task of going to inconvenient, lengthy traffic courts and to avoid warrants and arrest which can result from missed traffic court dates.

2. SEBA Nationwide Auto Repairs and Traffic Ticket Insurance, as described in claim 1, has a six (6) month to one (1) year policy.

3. The insurance coverage in claim 2 has premiums priced and regulated by the Insurance Commission of each state.

4. The insurance coverage in claim 1 is a means for covering the cost of car repairs for any normal wear and tear, broken part of your car.

5. The insurance coverage in claim 1 will cover qualified policyholders in all 50 states, as set by the policyholder's state Insurance Commission.

6. The insurance coverage in claim 1 will not cover any accidents or parts which stem from an auto or truck accidents, collision or body damage. Any needed bodily repairs or replacement parts will be at the expense and responsibility of the policyholder and/or their comprehension and collision insurance company.

7. The insurance coverage in claim 1 will not cover any pre-existing exterior and interior damage or pre-exiting lost parts on their car or truck. Any needed bodily repairs or replacement parts will be at the expense and responsibility of the policyholder and/or their comprehension and collision insurance company.

8. All vehicles insured under claim 1 must pass a pre-inspection and a diagnostic testing prior as a means for insurability approval. Once a prospective policyholder passes inspection, they are immediately insured under SEBA Nationwide Auto Repairs and Ticket Insurance.

9. All prospective policyholders will be required to submit a Department of Motors Vehicles record, as a means for insurability. After reviewing DMV records, coverage for ticket coverage will be determined.

10. Under claim 1, ticket insurance will only be approved for prospective policy holders without excessive DUI charges or prior repeat offenders for citations.

11. All ticket violations/citations must be reported immediately to be paid promptly, to avoid a penalty with ten (10) days.

12. Traffic Tickets violations/citations will be voided and not covered if reported after fifteen (15) days of issuance.

13. Immediate denial of coverage, under claim 1, includes and not limited to two (2) drunk driving violations.

14. Immediate denial of coverage, under claim 1, includes and not limited to 3 or more driving without a license.

15. Immediate denial of coverage, under claim 1, includes 4 or more prior convictions and/or driving violations.

16. Policyholders under claim 1, are allowed a total of three (3) service calls per year. After three (3) calls, SEBA Nationwide coverage will arrange service on a negotiated commercial rate, as a means for saving the policyholder money.

17. Under claim 1, only 2 service calls are allowed per month.

18. Under claim 1, only members listed on application are covered.
